(19) United States
(12) Patent Application Publication
(10) Pub. No.: US 2026/0344557 A1
(43) Pub. Date: Nov. 5, 2026

(54) PERCEPTION ASSEMBLY FOR CROP PLANTERS

(71) Applicant: Deere & Company, Moline, IL (US)

(72) Inventors: Joseph J. Akers, Denver, IA (US); Michael L. Halbrook, Thibodaux, LA (US); Jess J. Castagnos, Gonzales, LA (US); John A. Dighton, Napoleonville, LA (US); Garrett S. Drum, Perry, IA (US); Mahesh S. Bothe, Pune (IN); Sagar V. Jadhav, Pune (IN)

(21) Appl. No.: 19/198,647

(22) Filed: May 5, 2025

(51) Int. Cl. A01C 7/10; A01B 79/00; A01C 5/06; A01C 7/20

(52) U.S. Cl. CPC A01C 7/105; A01B 79/005; A01C 7/20; A01C 5/066

(57) ABSTRACT

A perception assembly is provided that can capture an image of a crop material deposited into a trench by a crop planter. The perception assembly can be configured to prevent entrance of ambient light into an inner area of the perception assembly, thereby eliminating associated interference with the image captured by an imaging device of the perception system. The perception system can also include flexible first and second curtains that are displaceable from corresponding home positions to deflected positions by engagement with either or both the crop material deposited in the trench or the adjacent ground surface. Such flexibility of at least the first curtain can assist with arresting a movement of the crop material after the crop material has been released from a planting assembly of the planter, as well as assist in laying the crop material in position for the image to be captured by the imaging device.

### FIELD OF THE DISCLOSURE

The present disclosure generally relates to planters for planting crop material, and more specifically, to a control curtain for a perception assembly of a planting assembly of a crop planter.

### BACKGROUND

Certain types of sugarcane harvesters can include both a base cutter assembly that severs sugarcane plants from the ground and a chopping assembly that chops the severed plants into billets. At least some of the billets can be collected and later used to seed the ground, such as during the next planting season. Moreover, during a subsequent planting operation, such billets can be placed in a trench formed in the ground, with the trench then being closed to cover the planted billets within the soil.

### SUMMARY

The present disclosure may comprise one or more of the following features and combinations thereof.

In one embodiment of the present disclosure, a perception assembly is provided that is configured to capture an image of a crop material deposited into a trench by a crop planter. The perception assembly can include a housing defining an inner area, the inner area having an open end positioned to be adjacent to the trench. The housing can include a first curtain that can define an upstream portion of the inner area, the first curtain not being rigidly coupled to the housing and positioned to be inwardly displaced by contact with at least the crop material from a first home position to a first deflected position. Additionally, the first curtain can be biased by at least one first biasing body to the first home position. The perception assembly can also include an imaging device that can be positioned to capture, through at least a portion of the inner area and the open end of the housing, the image of the crop material deposited by the crop planter in the trench. The imaging device can be positioned at a central location relative to the inner area of the housing. The perception assembly can also include a plurality of light devices configured to illuminate at least the inner area.

In another embodiment of the present disclosure, a perception assembly is provided that is configured to capture an image of a crop material deposited into a trench by a crop planter. The perception assembly can include a body assembly that can have a first curtain that can be inwardly displaceable between a first home position and a first deflected position in response to an engagement of the first curtain with at least the crop material. The body assembly can also include a second curtain that can be outwardly displaceable between a second home position and a second deflected position in response to an engagement of the second curtain with at least the crop material. Further, the first and second curtains can be positioned at opposite ends of the body assembly. Additionally, the body assembly can include a first sidewall and a second sidewall, the first and second sidewalls being opposed to each other and extend between the first and second curtains. Further, an inner area can be defined at least in part by the first and second curtains and the first and second sidewalls, the inner area having an open end positioned to be adjacent to the trench. The perception assembly can also include an imaging device that can be positioned to capture, through at least a portion of the inner area and the open end of the inner area, the image of the crop material deposited by the crop planter in the trench. The imaging device can be positioned at a central location relative to the inner area. Further, the perception assembly can include a plurality of light devices configured to illuminate at least the inner area.

These and other features of the present disclosure will become more apparent from the following description of the illustrative embodiments.

### BRIEF DESCRIPTION OF THE DRAWINGS

The disclosure contained herein is illustrated by way of example and not by way of limitation in the accompanying figures. For simplicity and clarity of illustration, elements illustrated in the figures are not necessarily drawn to scale. For example, the dimensions of some elements can be exaggerated relative to other elements for clarity. Further, where considered appropriate, reference labels have been repeated among the figures to indicate corresponding or analogous elements.

FIG. 1 illustrates a perspective view of an exemplary crop planter configured to plant crop material.

FIG. 2 illustrates a side perspective view of a portion of the crop planter shown in FIG. 1.

FIG. 3 illustrates an exemplary crop material in the form of a billet.

FIG. 4 illustrates a side perspective view of a perception assembly coupled to a planting assembly in the form of a row unit.

FIG. 5 illustrates a front side perspective view of the perception assembly shown in FIG. 4.

FIG. 6 illustrates a side perspective view of the perception assembly.

FIG. 7 illustrates a bottom view of the perception assembly.

FIG. 8 illustrates a cross-sectional view of the perception assembly taken along line 8 -8 in FIG. 5.

FIG. 9 illustrates a cross-sectional, front side perspective view of the perception assembly taken along line 9 -9 in FIG. 6.

FIG. 10 illustrates a cross-sectional, rear side perspective view of the perception assembly taken along line 9 -9 in FIG. 6.

FIG. 11 illustrates a simplified block diagram representation of a planter system that incorporates the exemplary perception assembly.

Corresponding reference numerals are used to indicate corresponding parts throughout the several views.

### DETAILED DESCRIPTION

While the concepts of the present disclosure are susceptible to various modifications and alternative forms, specific embodiments thereof have been shown by way of example in the drawings and will be described herein in detail. It should be understood, however, that there is no intent to limit the concepts of the present disclosure to the particular forms disclosed, but on the contrary, the intention is to cover all modifications, equivalents, and alternatives consistent with the present disclosure and the appended claims.

References in the specification to “one embodiment,” “an embodiment,” “an illustrative embodiment,” etc., indicate that the embodiment described can include a particular feature, structure, or characteristic, but every embodiment may or may not necessarily include that particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to effect such feature, structure, or characteristic in connection with other embodiments, whether or not explicitly described. Additionally, it should be appreciated that items included in a list in the form of “at least one A, B, and C” can mean (A); (B); (C); (A and B); (A and C); (B and C); or (A, B, and C). Similarly, items listed in the form of “at least one of A, B, or C” can mean (A); (B); (C); (A and B); (A and C); (B and C); or (A, B, and C).

In the drawings, some structural or method features can be shown in specific arrangements or orderings. However, it should be appreciated that such specific arrangements and orderings are not required. Rather, in some embodiments, such features can be arranged in a different manner or order than shown in the illustrative figures. Additionally, the inclusion of a structural or method feature in a particular figure does not imply that such feature is necessary in all embodiments and, in some embodiments, may not be included or may be combined with other features.

At least certain types of crop planters, and the associated crop material, such as, for example, sugarcane billets, being planted by those crop planters involve larger or wider furrows, also referred to as trenches, than other types of crop materials, such as, for example, small grains. The larger furrow size for certain crop materials can prevent the delivery system or other parts of the crop planter from obstructing ambient light that may affect the quality of information, such as images captured by an imaging device depicting crop material deposited in a furrow.

Embodiments of the subject disclosure provide a perception assembly for a planter system that at least shields an area in which crop material is planted in a furrow from ambient light. The configuration of the perception assembly can minimize potential interference from ambient light that may otherwise adversely impact the one or more imaging devices of the perception assembly in capturing accurate information of crop material individually, as that crop material is being planted in, or enters, a furrow. The improved accuracy can enhance the accuracy of associated determinations made by at least a planter system using that captured information, including with respect to determinations regarding the rates or volumes at which crop material is actually passing from the planting assembly and into the furrow. The perception assembly can also be configured to assist with arresting movement of crop material being deposited by the planter system into the furrow, as well as lay or smooth out the deposited crop material in the furrow, which can assist in putting the deposited crop material in a more presentable manner for the capturing of information by the perception assembly as well as assist in generally equally distributing the crop material in the furrow. Additionally, information captured by the imaging devices can be used to provide continuous feedback to an operator of the planter system regarding characteristics of the planting operation. These characteristics, also known as attributes, of the crop material, can be transmitted, displayed, and/or recorded by other systems, including, for example, published to an operation center.

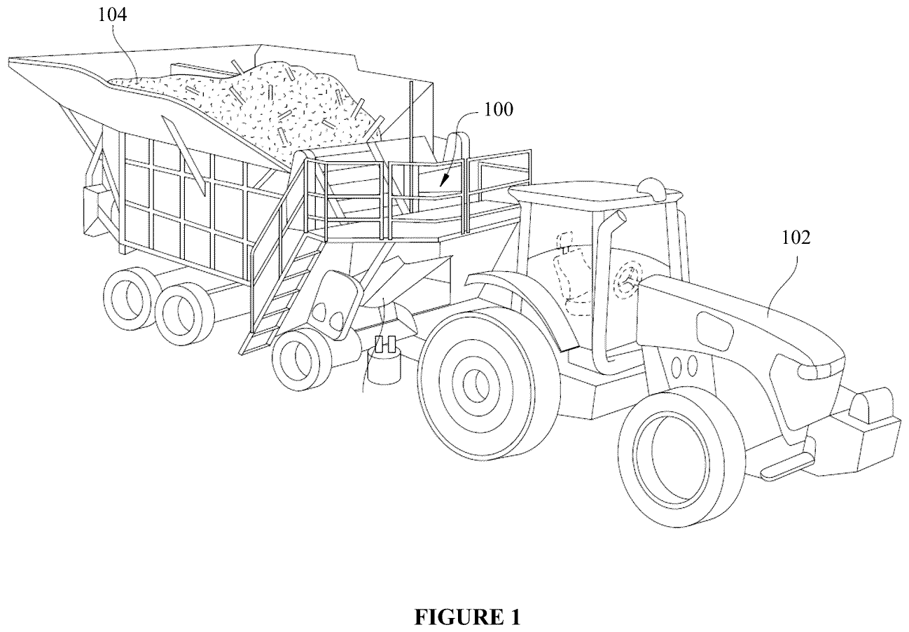

FIG. 1 illustrates a perspective view of an exemplary crop planter 100 that is configured to plant a crop material such as, for example, sugarcane. In the illustrated embodiment, the crop planter 100 is coupled to a tractor 102, the tractor 102 being configured to provide a propelling force to pull the crop planter 100 across a field. However, according to other embodiments, rather than being coupled to a tractor 102, the crop planter 100 can be self-propelled. Additionally, the crop planter 100 and/or tractor 102 can be autonomous, semi-autonomous, or manually operated machines, including vehicles and/or tools. With respect to manually operated embodiments, the crop planter 100 and/or tractor 102 can be locally operated such as, for example, by an operator that is on or within an operator cab of the tractor 102 or crop planter 100, or remotely operated, including with respect to an operator that is not positioned within or on either the tractor 102 or the crop planter 100.

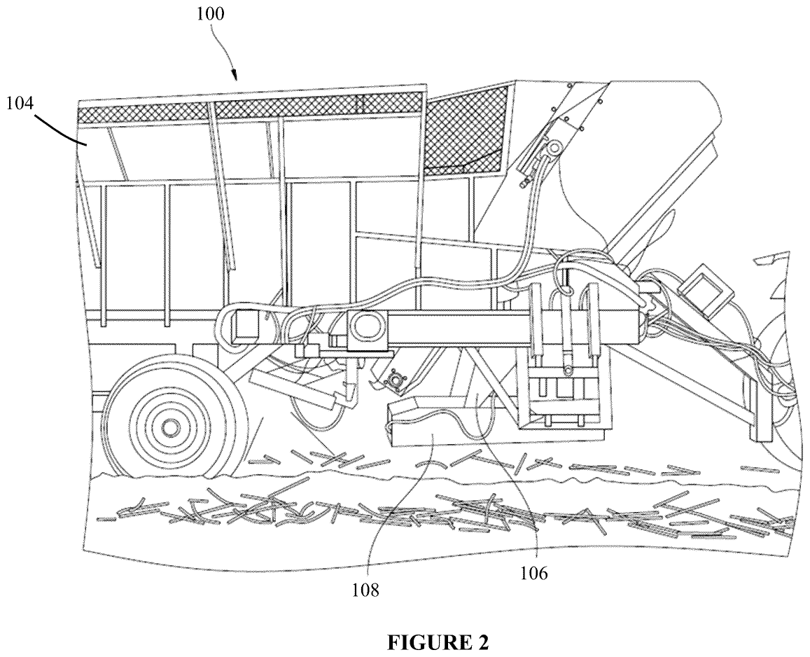

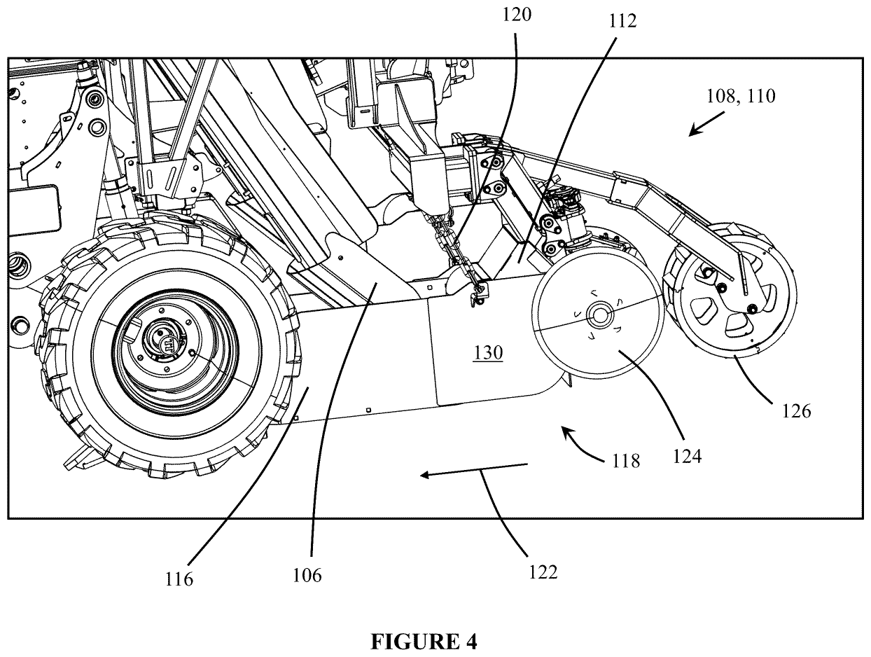

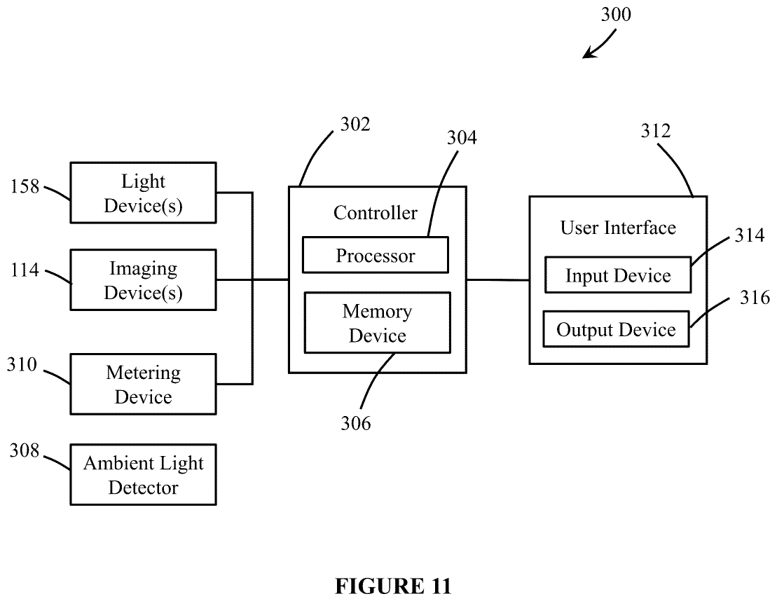

The illustrated exemplary crop planter 100 can include a hopper or container 104 that is configured to store, in bulk, crop material such as, for example, sugarcane billets. According to certain embodiments, the crop planter 100 can include a planting assembly 108 (FIG. 4), such as, for example, a single row unit, that can plant crop material received from the hopper 104 into a trench or furrow in the ground surface. The planting assembly 108 can include, for example, a metering device 310 (FIG. 11) that can be configured to control a rate of flow of crop material that is dispensed, including planted, by the planting assembly 108. For example, the metering device 310 can be configured to control a delivery of crop material from the hopper 104 to a planting chute 106 (FIG. 2) of the planting assembly 108 or other portion of the planting assembly 108, at a predetermined flow rate.

The planting chute 106 is configured to discharge and distribute the crop material to a ground surface of a field, and, moreover, within a furrow in the ground surface, in a predetermined pattern or manner. For example, in some implementations, as the crop planter 100 is pulled across a field, the planting assembly 108 (e.g., row unit) is configured to open or dig one or more furrows in the adjacent ground surface, and the planting chute 106 can subsequently deposit crop material (e.g., billet) into one or more of those furrows. Additionally, according to certain embodiments, the planting assembly 108 can, after crop material has been dispensed in the furrow, close the furrow such that the deposited crop material is covered by soil.

Although the exemplary embodiment shown in FIG. 1 illustrates a crop planter 100 having a single planting assembly 108, in other implementations, the crop planter 100 can include more than one planting assembly 108, each of which can include a planting chute 106. Additionally, or alternatively, the crop planter 100 can include multiple independently controlled planting assemblies 108, with each planting assembly 108 having independently controlled metering mechanisms and planting chutes 106.

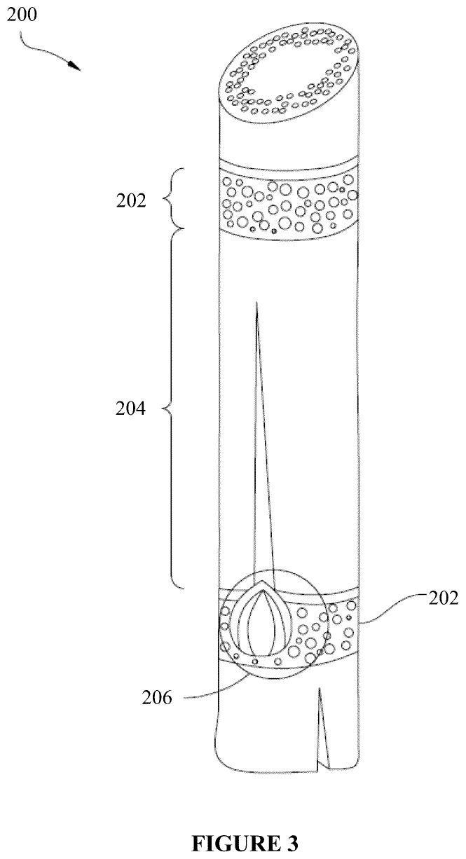

FIG. 2 illustrates a side perspective view of a portion of the crop planter 100 shown in FIG. 1. The illustrated crop planter 100 can include a perception assembly 112 (FIG. 4) that includes one or more imaging devices 114 (FIG. 10), such as, for example, a camera configured to capture information, such as, for example, photographs, video, video data, video segments, or images, as well as various combinations thereof, among other information. A variety of different types of imaging devices 114 can be used with the perception assembly 112. For example, the imaging device 114 can include, but are not limited to, optical cameras configured to capture static images, video, and/or video segments. Moreover, the imaging device 114 can include, for example, one or more red-green-blue (RGB or RGBD) cameras and/or multispectral cameras. The RGB cameras can be configured to capture color images that can provide spatial and attribute information of crop material, such as with respect to billets 200 (FIG. 3) as the billet 200 traverses through, or is released from, the planting chute 106 of the planting assembly 108 and/or when in the furrow. Multispectral cameras can capture information across different wavelengths of light, enabling further analysis of the attributes of the billets being planted using the planting assembly 108. Alternatively, or additionally, the imaging devices 114 can include LIDAR systems, among others, for generating precise, three-dimensional information about the billets 200 being planted and/or the surrounding environment.

The imaging device 114 can be positioned such that a field of view of the imaging device 114 can capture information regarding the operation of the planting assembly 108. For example, according to certain embodiments, the captured information obtained by the imaging device 114 can pertain to a flow rate of crop material passing through at least a portion of the planting assembly 108, including along the planting chute 106, and/or being deposited by the planting assembly 108 in a furrow. Such information can be used by a controller 302 of a planter system 300, as shown in FIG. 10, to determine whether crop material is being deposited in a furrow(s) at a predetermined rate(s), or whether overplanting or under-planting of the crop material is occurring. Such captured information can also provide an indication of whether skips are occurring, and, moreover, whether there is, or has been, occurrences of crop material not being released from the planting assembly 108 for depositing in a furrow. Such skips can, for example, occur in response to crop material becoming stuck or lodged within at least the planting assembly 108 in a manner that prevents crop material from being dispensed from the planting assembly 108. Such information obtained by the imaging device 114 can further be used by the controller 302 to identify and/or track elements, including attributes, of the crop material that is distributed during operation of the crop planter 100 and which is subsequently planted. In some implementations, the perception assembly 112 is configured such that the imaging device 114 is positioned so that all crop material distributed by the crop planter 100 can pass through the field of view of the imaging device 114. In other implementations, either or both the perception assembly 112 and the imaging device 114 can be positioned and/or configured so that a known proportion (e.g., 25%, 50%, 75%) of the volume of crop material distributed by the crop planter 100 will pass through the field of view of the imaging device 114.

FIG. 3 illustrates an example of crop material in the form of a sugarcane billet 200 that can be planted by crop planter 100. Each billet 200 can include one or more nodes 202, one or more internodes 204 extending between adjacent nodes 202, and one or more eyes 206 located on a corresponding node 202. One of the eyes 206 is illustrated in FIG. 3 in an enlarged view. Together, the nodes 202, internodes 204, and eyes 206 of each individual billet 200 can define a plurality of attributes of a single billet 200. The attributes of at least some of the single billets 200 being planted can be imaged by the imaging device 114. Such individual attributes can include, but are not limited to, the overall billet length (e.g., the distance between the two distal ends of the billet 200), the internodal length (e.g., the length between a particular set of adjacent nodes 202), the average internodal length (e.g., the average of all internodal lengths found on an individual billet 200), the node number (e.g., the number of nodes 202 found on a particular billet 200), the eye number (e.g., the number of eyes 206 found on a particular billet 200), and the billet diameter (e.g., the average diameter of a particular billet 200). While FIG. 3 depicts the crop material as a billet 200 having more than one node 202, the billet can have a variety of other configurations, including billets 200 having multiple eyes 206 or few eyes 206. Alternatively, the crop material can be one or more eyes 206, or another type of crop material other than sugarcane.

FIG. 4 illustrates the exemplary perception assembly 112, which is configured to image billets 200 deposited by the planting chute 106 in a furrow. With respect to at least certain planting assemblies 108, the billets 200 can be directed by the planting chute 106 and fall into a trencher 116 having a front end or front portion 118 suspended from a frame of the crop planter 100 by a chain 120. The use of the chain 120 enables the trencher 116 to float relative to the crop planter 100. In one embodiment, the imaging device 192 is fixed to the trencher 116 and moves with the trencher 116 as it moves with respect to the frame of the planting assembly 108. In another embodiment, the perception assembly 112 is fixed with respect to the frame of the planting assembly 108 and the trencher 116 moves with respect to the perception assembly 112. The front end 118 can include a narrow profile that can provide a leading portion of the trencher 116 that can act as an opener for opening the trench. As the crop planter 100 moves in a forward direction 122, the front end 118 starts forming a trench in the soil where billets 200 are deposited. As the trench is opened, the billets 200 fall to the ground within the formed trench. After being placed in the trench, closers 124 close the trench and a rotating wheel or tamper 126 applies pressure to the soil to further close the trench.

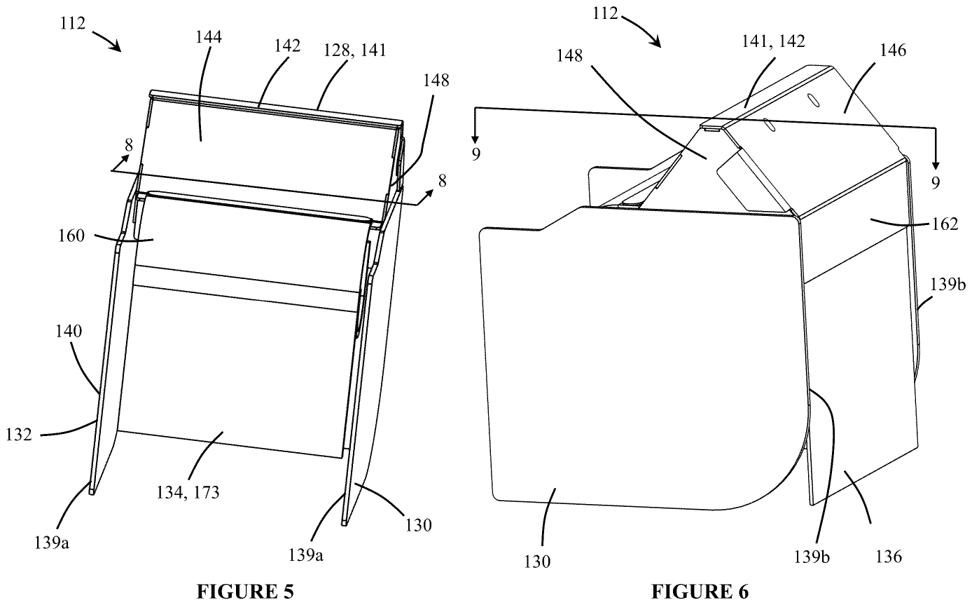

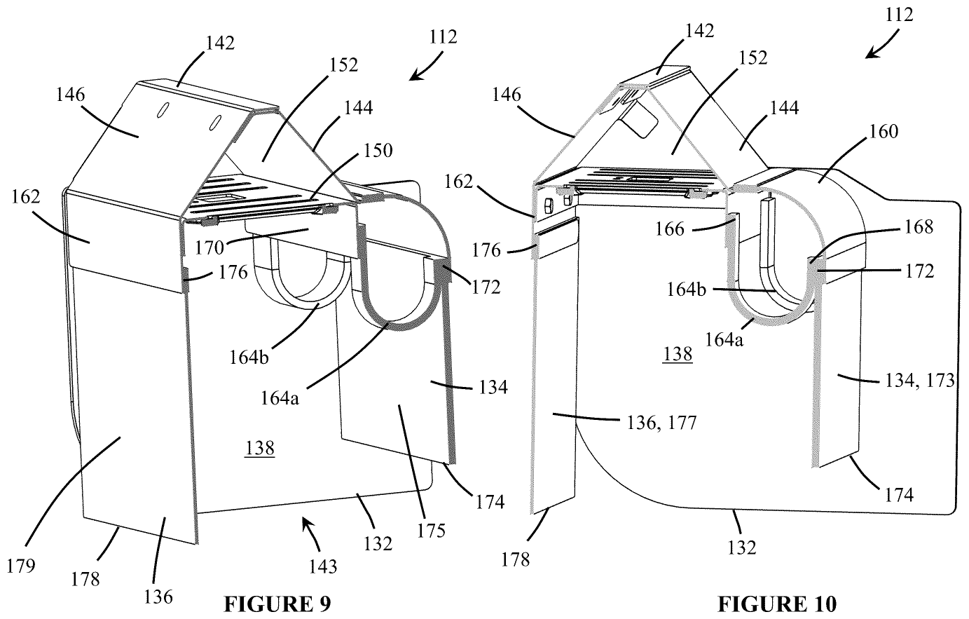

FIGS. 5-10 illustrate various additional views of the exemplary perception assembly 112 shown in FIG. 4. As shown, the housing 128 can include a body assembly 140 and a top assembly 141. The body assembly 140 can include the first side wall 130 and an opposing second side wall 132, and can further include a first curtain 134 and a second, opposing curtain 136, each of the curtains 134, 136 extending between the first and second side walls 130, 132. As shown in FIG. 6, according to certain embodiments, the second curtain 136 can be positioned generally adjacent to a second, rear end 139b of both the first and second side walls 130, 132, respectively. Conversely, as seen in FIG. 5, according to certain embodiments, the first curtain 134 can be inwardly offset to, and not adjacent to, an opposing first end 139a of the first and second side walls 130, 132, respectively. Each of the first and second side walls 130, 132 and the first and second curtains 134, 136 can generally define an inner area 138 (FIG. 9) of the body assembly 140, and, moreover, of the perception assembly 112. According to such an embodiment, relative to the forward direction 122 of travel, the first curtain 134 can generally define an upstream portion of the inner area 138, while the second curtain 136 can generally define a downstream portion of the inner area 138. Additionally, at least the first and second side walls 130, 132 and the first and second curtains 134, 136 can be configured to minimize, if not prevent, the entrance of ambient light into the inner area 138.

The top assembly 141 can be positioned above, and/or on, at least a portion of the body assembly 140. According to certain embodiments, the top assembly 141 can include first and second side walls 144, 146 that are downwardly sloped from a ridge wall 142 of the top assembly 141. Such a configuration can at least aid in preventing or minimizing the formation of debris on the perception assembly 112. The top assembly 141 can further include an opposing pair of gable walls 148 positioned between the ends of the first and second walls 144, 146 and an upper portion of an adjacent one of the first side wall 130 or the second sidewall 132 of the body assembly 140. At least the first and second walls 144, 146, as well as the gable walls 148, can generally define an interior area 152 (FIG. 9) of the top assembly 141. The interior area 152 of the top assembly 141 can be configured to house at least portions of various components of the perception assembly 112, including, but not limited to, a portion of at least one or more imaging devices 114 (FIG. 8) and associated light devices 158 (FIG. 8) among other components. While the top assembly 141 is depicted in at least FIGS. 5 and 6 as having a generally triangular cross-sectional shape, the top assembly 141 can have a variety of other shapes and configurations including, but not limited to, a combination of different shapes.

The perception assembly 112 can further include a front retainer wall 160 and a rear retainer wall 162 that can, for example, provide a transition between the top assembly 141 and the body assembly 140. Moreover, the front and rear retainer walls 160, 162 can be configured to at least assist the body assembly 140 with blocking a passage of ambient light into the inner area 138 of the body assembly 140. For example, according to certain embodiments, the body assembly 140, front retainer wall 160, rear retainer wall 162, and/or the top assembly 141 can be generally configured to provide the housing 128 with generally one open end 143 (FIG. 9) that is fluidly coupled to, or, alternatively, part of, the interior area 138 of the body assembly 140. As seen in at least FIG. 9, this singular open end, as generally indicated by opening 145, is positioned to be adjacent to the ground, and, moreover, to a furrow in which one or more billets 200 are being, or have been, planted. Such a configuration of the housing 128 can minimize, if not prevent, a passage of ambient light into the interior area 138 so that the perception assembly 112 can generally control the level of illumination within the interior area 138 via selective operation of one or more light devices 158.

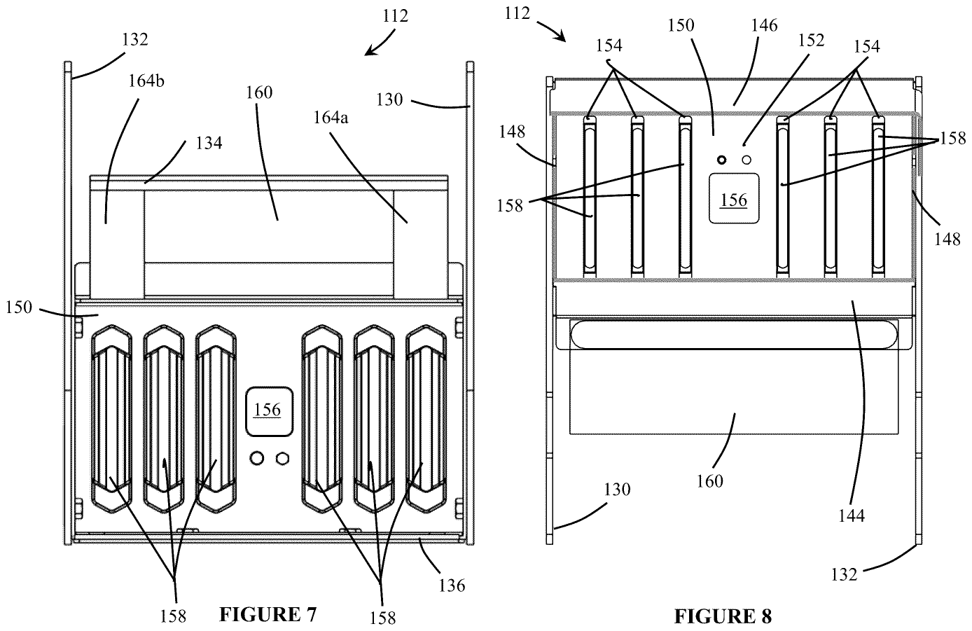

The light devices 158 can provide the perception assembly 112 with a controllable lighting environment, as the configuration of the perception assembly 112 blocks ambient light from the inner area 138. According to certain embodiments, the light devices 158 can comprise a plurality of light sources, including one or more arrays of lights, positioned on either side of the imaging device 114. For example, as seen in at least FIGS. 7 and 8, the light devices 158 can, according to certain embodiments, be arranged in at least two arrays of light devices 158, each array comprising a plurality of light devices 158, such as LED lights. Moreover, each array can, according to an exemplary embodiment, have three light devices 158, with each light device 158 containing 9 LED lights. Further, rather than producing focused light, the light devices 158 can provide a diffused light pattern, where the light devices 158 do not collectively direct the light to a specific point. Accordingly, the center of each of the light devices 158 in a light array can differ in that the light devices 158 do not narrow the light to the same point. By diffusing the light, the illumination provided by the light devices 158 can be evenly distributed over the surface area at the bottom of the furrow, resulting in a generally uniform brightness without high spots and low spots. Additionally, the plurality of light devices 158 can be configured to provide diffused illumination to inner area 138 in a manner that reduces or prevents shadow interference, including from the below-discussed biasing elements 164a, 164b, within the field of view of imaging device 114. The light devices 158 can have a sufficient angle of coverage and/or a sufficient quantity of lights to illuminate the inner area 138 from one side to the opposite side of the inner area 138 in a manner that contributes to the distribution of lighting while avoiding the presence of shadows and hotspots.

Additionally, or alternatively, the front and rear retainer walls 160, 162 can provide a location where first, upper ends 172, 176 of the first and second curtains 134, 136, respectively, can be secured to the body assembly 140 of the perception assembly 112, as seen, for example, in FIGS. 9 and 10. The front and rear retainer walls 160, 162 can be coupled to the corresponding first and second curtains 134, 136, respectively, in various manners, including, for example, by one or more mechanical fasteners such as bolts, screws, or pins, as well as clamps or clamping forces, and/or adhesives, among other manners of coupling. Such coupling of the first and second curtains 134, 136 to the associated front or rear retainer wall 160, 162 can accommodate the bending, flexing, or deformation of either or both the first and second curtains 134, 136, as discussed below.

The housing 108 and/or perception assembly 112 can also include an upper wall 150 that can be positioned between the inner area 138 of the body assembly 140 and the interior area 152 of the top assembly 141. Thus, for example, the upper wall 150 can generally define an upper portion of the inner area 138 of the body assembly 140 and a lower portion of the interior area 152 of the top assembly 141.

As seen in at least FIGS. 7 and 8, the upper wall 150 can include at least an aperture 156 for placement of one or more imaging devices 114, and/or through which one or more imaging devices 114 in the interior area 152 of the top assembly 141 can view the inner area 138 of the body assembly 140 and/or crop material (e.g., billets 200) deposited in, or being deposited into, a furrow. Additionally, the upper wall 150 can include one or more light orifices 154 that can receive at least a portion of one or more of the light devices 158 used to illuminate the inner area 138 and/or the adjacent portion of the ground, including furrow, and any associated crop material.

The aperture 156 can be positioned such that the imaging device 114 is located above a furrow along which the perception assembly 112 is traveling, allowing the imaging device 114 to capture one or more images of the billets 200 being planted in the furrow. As illustrated in FIGS. 7 and 8, the aperture 156, and thus the imaging device 114, can, according to certain embodiments, be positioned at a generally central or middle location between the first sidewall 130 and the second sidewall 132, and at a vertical height above the ground sufficient for the imaging device 114 to capture an image of a sufficiently large area to encompass the furrow and one or more billets 200 positioned in the furrow. Additionally, by the aperture 156, and thus the imaging device 114, being positioned at a generally central location, the imaging device 114 can be generally surrounded by a plurality of light devices 158.

The perception assembly 112 can be constructed from a variety of materials, or combinations of materials. For example, the top assembly 141 and at least a portion of the body assembly 140 can be constructed from metal, including, but not limited to, sheet metal. With respect to the body assembly 140, the first curtain 134 and the second curtain 136 can be constructed from a flexible material, including, for example, an elastomer, such, as for example, rubber, or a composite material having rubber, such as, for example, a conveyor material in which a textile material is encapsulated in rubber. Alternatively, according to certain embodiments, either or both the first curtain 134 and the second curtain 136 can be a plurality of bristles, or provide one or more brushes. As discussed below, the material for the first and second curtains 134, 136 can have enough flexibility to accommodate contact with billets 200 in, or around, a furrow as the first and second curtains 134, 136 travel over the billets 200, while also having sufficient rigidity to arrest a tumbling movement of the billets 200 as the billets transition from a motion associated with release from the planting assembly 108, and, moreover, the planting chute 106, and eventually coming to a rest in the furrow. Additionally, the front and rear retainer walls 160, 162 can be biasing bodies that are configured to provide a biasing force, including a spring force, to further accommodate the bending or flexing movement of the associated first and second curtains 134, 136 while also biasing the curtain 134, 136 to a home position. Thus, according to certain embodiments, the front and rear retainer walls 160, 162 can be constructed from a similar rubber or rubber encapsulated material as the first and second curtains 134, 136, or other material having sufficient elasticity to bias the associated first and second 134, 136 to return to a home position, as shown, for example, in FIGS. 5 and 6.

Additionally, the first and second curtains 134, 136, can be configured to, when not engaged with billets 200 and/or the ground surface, be at the home position at which the first and second curtains 134, 136 can be generally parallel to each other, perpendicular to the adjacent first and second sidewalls 130, 132, and/or perpendicular to the adjacent ground surface. When engaged with billets 200 and/or the ground surface, or debris along the associated field, the first and second curtains 134, 136 can be deformed, bent, or deflected in response to such engagement while also providing sufficient rigidity to arrest movement of the billets 200. For example, during a planting operation in which the planter 100 is traveling in a foreword direction, such engagement can result in the first curtain 134 flexing generally inwardly into the inner area 138, while such engagement can result in the second curtain 136 flexing outwardly away from the inner area 138. Upon disengagement with the billet 200 and/or ground surface, the first and second curtains 134, 136 can have sufficient elasticity to return to the home position. Such movement of the first and second curtains 134, 136, as well as the subsequent return to the associated home position, can be aided by a spring like biasing force provided by the associated front and rear retainer walls 160, 162.

The first, upstream curtain 134, which can feature relatively flat front and rear walls 173, 175, can serve to smooth or lay billets 200 in the furrow and block the entrance of ambient light into the inner area 138. By laying out or smoothing the billets 200 in the furrow, the first curtain 134 can assist in putting the billets 200 in a more presentable manner for the capturing of information by the imaging device 114, and may also assist in generally equally distributing the billets 200 in the furrow. Thus, such a configuration can allow the first curtain 134 to assist is smoothing out the trajectory, or slowing the movement, of the billets 200 as the billets 200 are released from the planting chute 106 before, or after the billets 200, contact the adjacent ground surface. For example, according to certain embodiments, or in certain situations, billets 200 released from the planting chute 106 can initially contact the first curtain 134 before subsequently falling or dropping to the ground. Additionally, or alternatively, at least some of the crop material dispensed from the chute 126 may contact the ground surface and subsequently contact the first curtain 134 before falling or dropping from the first curtain 134 to the ground.

With the billet 200 on the ground, the first curtain 134 can extend to a vertical height above the ground and/or billet 200 at which the first curtain passes, or sweeps, over, while engaging, the billets 200, which can also assist in arresting the movement of the billet 200. For example, a second end 174 of the first curtain 134 can be vertically positioned above, or offset from, the adjacent ground surface by a distance that accommodates the front wall 173 coming into contact with at least some billets 200, which can result in the inward bending, deflection, of deformation of the first curtain 134 away from the home position and to a deflected position as the billets 200 pass below the second end 174, and thus the first curtain 134 and into the inner area 138. During such sweeping engagement with the billets 200, the first curtain 134 can thus also be bent, deformed, or deflected to the deflected position by the contact with at least the billets 200.

Such arresting of the movement of the billet 200 and/or sweeping of the billet 200 by the first curtain 134, rather than allowing the billet 200 to eventually, and randomly, come to a stop on its own, can also assist in positioning the billet 200 at a generally central location within the furrow, as well as occur with timing relative to the depositing of the billet 200 by the planting assembly 108 in a manner that can assist in generally evenly distributing the billets 200 within the furrow. By the first curtain 134 at least assisting in arresting the movement of the billet 200 and smoothing or laying out the billets 200, unlike traditional systems, and with the imaging device 114 be positioned at a generally central location within the body assembly 140, the imaging device 114 can capture information regarding the settled billet 200 at a generally central location relative to the inner area 138. By capturing information regarding the settled billet 200 at a generally central location relative to the inner area 138, the configuration of the perception assembly 112 can resolve at least certain geometric and spacing deficiencies experienced by traditional systems. Additionally, the first curtain 134 can also assist in shielding the imaging device 114 from debris that is upstream of the first curtain 134, including, for example, the distribution of fertilizer and generation of dust that may occur during a planting operation by the crop planter 100.

As seen in at least FIGS. 9 and 10, the body assembly 140 can also include one or more biasing elements 164a, 164b, which can also be biasing bodies, having a first end coupled to the first curtain 134, such as, for example, to the rear wall 175 of the first curtain 134, and a second end coupled to another portion of the body assembly 140. Moreover, in the example shown in FIGS. 9 and 10 in which a pair of biasing elements 164a, 164b are shown, the first end of the biasing elements 164a, 164b can be coupled to the rear wall 175 of the first curtain 134 at an area adjacent to the first end 172 of the first curtain 134, and a second end of the biasing elements 164a, 164b can be coupled to a support plate 170 that can downwardly extend from the upper wall 150 into the inner area 138, and that may be generally rigid. The biasing elements 164a, 164b can also provide a spring-like force against the first curtain 134 that can at least assist in biasing the first curtain 134 to the home position. Further, according to certain embodiments, the biasing elements 164a, 164b can be constructed from materials similar to those used for the first curtain 134 and/or the front and rear retainer walls 160, 162. According to certain embodiments, the one or more biasing elements 164a, 164b comprises a pair of biasing elements 164a, 164b that are sized and positioned, including being positioned apart, so as to minimize, if not prevent, biasing elements 164a, 164b from obstructing the field of view of the imaging device 114, and, moreover, interfering with the images captured by the imaging device 114. As seen in at least FIGS. 9 and 10, the biasing elements 164 a, 164 b are vertically adjacent to the front retainer wall 160, or vertically oppose each other, and have an arcuate shape that extends in a direction that is generally opposite of the direction of the arcuate shape of the front retainer wall 160.

As previously mentioned, the first curtain 134 is suspended from the flexible front retainer wall 160 and is not rigidly coupled to the body assembly 140. The compliance offered by the suspension of the first curtain 134 from the front retainer wall 160, and the vertical positioning of the second end 174, along with the materials and configurations of both the first curtain 134 and the front retainer wall 160, can impart sufficient flexibility to the first curtain 134 to accommodate large billets 200 passing underneath the second end 174, while preventing billets 200 from becoming lodged under the first curtain 134 and creating an obstruction, yet still maintain adequate rigidity to halt the tumbling motion of the billet 200. Further, the biasing elements 164a, 164b, alone or in combination with the front retainer wall 160, can provide sufficient force, including functioning as restrictors, to restrict the extent the first curtain 134 can be inwardly displaced, and, moreover, displaced into the inner area 138, as well as assist in returning the first curtain 134 to the home position.

Regarding the second curtain 136, as illustrated in FIGS. 9 and 10, a second end 178 of the second curtain 136 can extend vertically beyond, or below, the second end 174 of the first curtain 134. According to certain embodiments, the second curtain 136 can be generally aligned with the bottom of the furrow. Consequently, the second end 178 of the second curtain 136 can be positioned closer to the ground than the second end 174 of the first curtain 134. During a planting operation, once the billet(s) 200 is/are situated on the ground and within the furrow, the perception assembly 112 can engage the billet(s) more aggressively with the second curtain 136 than the first curtain 134. Moreover, the second curtain 136 can effectively comb over the bottom of the furrow and/or top of the billet(s) 200 in the furrow as the second curtain 136 moves back or outwardly relative to the inner area 138. Thus, the second curtain 136 can have sufficient flexibility to be maneuvered over, while in contact with, the billet(s) 200 situated in the furrow. Moreover, similar to the first curtain 134, the second curtain 136 can be suspended from the second retainer wall 162, and be configured to bend, deform, or deflect away from a home position to a deflected position as the second curtain 136 engages the ground surface and/or billets 200. Further, the second retainer wall 162 can be configured to provide a spring effect that can assist in biasing the second curtain 136 to the home position, as seen in at least FIGS. 6 and 9.

Similar to the first curtain 134, the second curtain 136 is configured to assist in preventing or minimizing at least ambient light from entering into the inner area 138. Additionally, the second curtain 136 can also temporarily block the soil thrown by the closers 124 from accumulating on the dispensed billet 200, thereby extending the amount of time the imaging device 114 has to capture an image of the billet 200 at the bottom of the furrow.

FIG. 11 illustrates one implementation of a perception assembly 300 for imaging sugarcane billets 200 that are deposited in a furrow. The perception assembly 300 includes the controller 302, which can be configured to identify and document billet characteristics, planting conditions, and planting operations. In some implementations, the identification and documentation of billet planting conditions are used to modify or improve billet planting procedures and the operation of the crop planter 100 and/or the tractor 102. Billet characteristics include, but are not limited to, the billet characteristics illustrated and described for the billet 200 shown in FIG. 3, among other crop materials. Billet planting conditions can include a quantity of billets 200 imaged in the field of view of the imaging device 114 and/or a planting rate of planting or depositing the billets 200 in the trench. Planting conditions can also include the number of billets 200 planted within a portion of the trench to identify a number of billets 200 planted over a predetermined portion of the trench. Images provided by the imaging device 114 can be transmitted to the controller 302, where the images are processed to identify billet characteristics, configurations, and billet planting. Based on an image analysis software residing in the controller 302, the controller 302 can identify the billet conditions. In one implementation, a crop identifier can be coupled to the controller 302, which is configured to identify features of the billets 200 located in the field of view of the imaging device 114.

The controller 302, in different implementations, is a single controller or a plurality of controllers, which can be operatively coupled to one another. As shown in FIG. 11, the controller 302 includes a processor 304 and a memory 306 configured to execute instructions (i.e., algorithmic steps) stored in the memory 306. The controller 302 can be operatively coupled (i.e., hardwired or connected wirelessly) to other components of the crop planter 100 or the tractor 102. If hardwired, the controller 302 can be connected to the components via wires, and if connected wirelessly, the controller 302 can be connected to the components via Wi-Fi, Bluetooth, NFC, or other known means of wireless communication. Thus, the controller 302 can be positioned on the crop planter 100 or the tractor 102 or both. The controller 302 can also be positioned remotely therefrom, such as in a cloud system.

The controller 302 can be operatively connected to one or more imaging devices 114, one or more light devices 158, and an ambient light detector 308. In one implementation, the ambient light detector 308 can detect ambient light within the inner area 138 of the perception assembly 112, and, moreover, the body assembly 140, and generate an ambient light signal that is transmitted to the controller 302 to adjust light intensity of the light devices 158. The imaging device or devices 114 are positioned generally along a longitudinal centerline of the trencher 150 to capture electronic images of the deposited billets 200, which include, but are not limited to, complete billets, partial billets, and crop residue being deposited with the billets 200.

The controller 302 executes or otherwise relies upon computer software applications, components, programs, objects, modules, or data structures, etc. Software routines, resident in the included memory 306 or other memory, are executed, such as, for example, by the processor 304, in response to signals received from the connected devices. In other implementations, the computer software applications are located in the cloud. The executed software includes one or more specific applications, components, programs, objects, modules or sequences of instructions typically referred to as “program code.” The program code includes one or more instructions located in memory and other storage devices that execute the instructions that are resident in memory, which are responsive to other instructions generated by the system, or which are provided by a user interface 312. The processor 304 is configured to execute the stored program instructions.

The controller 302 is operatively connected to the user interface 312, which in one implementation, is located in a cab of the tractor 102. Other locations of the user interface are contemplated, including a remotely located user interface for an autonomous sugarcane harvester. The user interface 312 is operatively coupled to the controller 302 such that a user operates functions through, for example, an input device 314 of the user interface 312. The user interface 312 includes one or more user inputs identified by, for example, user-selectable buttons of the input device 314 for the operator to adjust functioning of the crop planter 100 or the tractor 102. For instance, in one implementation, the user interface 312 includes an output device 316, such as, for example, an image display or touch screen, that receives either moving images or still images provided by the imaging device(s) 114. Based on the provided images, the operator can speed up or slow down the tractor 102 to improve the planting of billets 200. In another implementation, the operator can adjust a metering device 310 to speed up or slow down the depositing of billets 200, provided by the metering device 310, to the trench.

In some implementations, images provided by the imaging device 114 are used to identify and locate a position of each of the eyes 206. The eyes 206 can be documented or the number of eyes 206 can be counted by the controller 302. In some implementations, images of the billets 200 can be used to identify the quality of the seed cane or billets 200 to predict a survivability of the seed cane and whether the quality is sufficient to provide a viable sugarcane plant. In a further implementation, the volume of billets 200 can be measured by utilizing a three-dimensional imaging device configured to make three-dimensional measurements.

While the disclosure has been illustrated and described in detail in the foregoing drawings and description, the same is to be considered as exemplary and not restrictive in character, it being understood that only illustrative embodiments thereof have been shown and described and that all changes and modifications that come within the spirit of the disclosure are desired to be protected.

1. A perception assembly that is configured to capture an image of a crop material deposited into a trench by a crop planter, the perception assembly comprising:
a housing defining an inner area, the inner area having a open end positioned to be adjacent to the trench, the housing comprising a first curtain that defines an upstream portion of the inner area, the first curtain not being rigidly coupled to the housing and positioned to be inwardly displaced by contact with at least the crop material from a first home position to a first deflected position, the first curtain being biased by at least one first biasing body to the first home position;
an imaging device positioned to capture, through at least a portion of the inner area and the open end of the housing, the image of the crop material deposited by the crop planter in the trench, the imaging device positioned at a central location relative to the inner area of the housing; and
a plurality of light devices configured to illuminate at least the inner area.

2. The perception assembly of claim 1, wherein the at least one first biasing body comprises a front retainer wall coupled to a first end of the first curtain, and which couples the first curtain to the housing.

3. The perception assembly of claim 2, wherein the at least one first biasing body further comprises a biasing element having a first end coupled to a rear wall of the first curtain, and a second end coupled to a support plate of the housing.

4. The perception assembly of claim 1, wherein the housing further comprises a second curtain that defines a downstream portion of the inner area, the second curtain not being rigidly coupled to the housing and positioned to be outwardly displaced by contact with at least the crop material from a second home position to a second deflected position, the second curtain being biased by at least one second biasing body to the second home position.

5. The perception assembly of claim 4, wherein the at least one second biasing body comprises a rear retainer wall coupled to a first end of the second curtain, and which couples the second curtain to the housing.

6. The perception assembly of claim 4,
wherein the first curtain vertically extends between a first end and a second end of the first curtain, the second end of the first curtain being positioned to be closer to the trench than the first end of the first curtain, and
wherein the second curtain vertically extends between a first end and a second end of the second curtain, the second end of the second curtain being positioned to be closer to the trench than both the first end of the second curtain and the second end of the first curtain.

7. The perception assembly of claim 6, wherein the housing comprises a body assembly and a top assembly, the inner area being located within the body assembly, the top assembly positioned above the body assembly and defining an upper inner area, the inner area and the upper inner area being separated by an upper wall, the image device and the plurality of light devices being coupled to the upper wall.

8. The perception assembly of claim 7:
wherein the housing further comprises a first sidewall and a second sidewall, the first sidewall, the second sidewall, the first curtain, and the second curtain defining at least a portion of the inner area, and
wherein the top assembly, the first sidewall, the second sidewall, the first curtain, and the second curtain are configured to prevent an entrance of an ambient light into the inner area.

9. The perception assembly of claim 8, wherein the upper wall includes an aperture positioned about a central location of the upper wall, the aperture configured to receive a placement of the imaging device.

10. The perception assembly of claim 8, wherein the upper wall includes an aperture positioned about a central location of the upper wall, the aperture configured to provide an opening through which the imaging device can captured the image of at least the crop material.

11. A perception assembly that is configured to capture an image of a crop material deposited into a trench by a crop planter, the perception assembly comprising:
a body assembly comprising:
a first curtain that is inwardly displaceable between a first home position and a first deflected position in response to an engagement of the first curtain with at least the crop material,
a second curtain that is outwardly displaceable between a second home position and a second deflected position in response to an engagement of the second curtain with at least the crop material, the first and second curtains positioned at opposite ends of the body assembly,
a first sidewall and a second sidewall, the first and second sidewalls being opposed to each other and extend between the first and second curtains, and
an inner area defined at least in part by the first and second curtains and the first and second sidewalls, the inner area having an open end positioned to be adjacent to the trench;
an imaging device positioned to capture, through at least a portion of the inner area and the open end of the inner area, the image of the crop material deposited by the crop planter in the trench, the imaging device positioned at a central location relative to the inner area; and
a plurality of light devices configured to illuminate at least the inner area.

12. The perception assembly of claim 11, further comprising at least one first biasing body configured to bias the first curtain to the first home position.

13. The perception assembly of claim 12, wherein the at least one first biasing body comprises a front retainer wall coupled to a first end of the first curtain, the first curtain not being rigidly coupled to either of the first and second sidewalls.

14. The perception assembly of claim 13, wherein the at least one first biasing body further comprises a biasing element having a first end coupled to a rear wall of the first curtain, and a second end coupled to a support plate of the body assembly.

15. The perception assembly of claim 12, further comprising at least one second biasing body configured to bias the second curtain to the second home position.

16. The perception assembly of claim 15, wherein the at least one second biasing body comprises a rear retainer wall coupled to a first end of the second curtain, the second curtain not being rigidly coupled to the first and second sidewalls.

17. The perception assembly of claim 11:
wherein the first curtain vertically extends between a first end and a second end of the first curtain, the second end of the first curtain being positioned to be closer to the trench than the first end of the first curtain, and
wherein the second curtain vertically extends between a first end and a second end of the second curtain, the second end of the second curtain being positioned to be closer to the trench than both the first end of the second curtain and the second end of the first curtain.

18. The perception assembly of claim 11, further comprising a top assembly positioned above the body assembly and defining an upper inner area, the inner area and the upper inner area being separated by an upper wall, the image device and the plurality of light devices being coupled to the upper wall.

19. The perception assembly of claim 18, wherein the body assembly and the top assembly are configured to prevent an entrance of an ambient light into the inner area.

20. The perception assembly of claim 19, wherein the upper wall includes an aperture positioned about a central location of the upper wall, the aperture configured to at least one of receive a placement of the imaging device and provide an opening through which the imaging device can captured the image of at least the crop material.
